(19) United States
(12) Patent Application Publication
(10) Pub. No.: US 2005/0282041 A1
(43) Pub. Date: Dec. 22, 2005

(54) Magnetic recording medium

(75) Inventors: Nobuo Yamazaki, Kanagawa (JP); Masatoshi Takahashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/155,616

(22) Filed: Jun. 20, 2005

(30) Foreign Application Priority Data
Jun. 18, 2004 (JP) P.2004-180710

(51) Int. Cl. G11B 5/708

(52) U.S. Cl. 428/842.8

(57) ABSTRACT

A magnetic recording medium comprising: a non-magnetic support; and a magnetic layer comprising a hexagonal ferrite and a binder, wherein the magnetic layer has a thickness of from 30 to 100 nm, a coercive force of from 3,000 to 4,200 Oe and a magnetization reversal volume of from 3×10⁻¹⁸ to 10×10⁻¹⁸ mL, and the hexagonal ferrite has a tabular ratio of from 2 to 3.

### FIELD OF THE INVENTION

The present invention relates to a coating type magnetic recording medium with high recording density. In particular, the invention relates to a magnetic recording medium for high density recording, which contains a hexagonal ferrite fine powder in a magnetic layer.

### BACKGROUND OF THE INVENTION

Hitherto, a magnetic head replying upon electromagnetic induction as an operation principle (induction type magnetic head) has been employed and become widespread. However, in using the magnetic head in a recording/reproducing region with higher density, limits start to be seen. That is, in order to obtain a large reproducing output, it is necessary to increase the number of turns of coil of a reproducing head. However, in this case, the inductance increases, and the resistance at a high frequency increases. As a result, there was encountered a problem that the reproducing output is lowered. In recent years, a reproducing head replying upon MR (magnetic resistance) as an operation principle is proposed and starts to be used in hard disks and the like. According to an MR head, a reproducing output of several times is obtained as compared with the induction type magnetic head. Also, since the MR head does not use an induction coil, an instrument noise such as an impedance noise is largely reduced and a noise of the magnetic recording medium is reduced so that it has become possible to obtain a large S/N ratio. In other words, if the noise of the magnetic recording medium which has hitherto been hided by the instrument noise is minimized, satisfactory recording/reproducing can be achieved so that it should become possible to markedly enhance high-density recording characteristics.

JP-A-6-342515 discloses a magnetic recording medium for MR head reproducing having a thickness of magnetic layer of not more than 0.5 μm, an Ra of not more than 5 nm and an Hc of 1,100 Oe (88 kA/m) or more.

JP-A-8-221740 discloses a magnetic recording medium comprising a non-magnetic support having provided thereon a magnetic layer having a hexagonal ferrite dispersed in a binder, wherein the hexagonal ferrite has a mean particle size of not more than 0.05 μm, a coercive force Hc of the magnetic layer is, for example, 2,000 Oe (160 kA/m) or more, and a peak value of magnetostatic interaction ΔM is from 0.19 to 1.50.

JP-A-6-195685 discloses a magnetic recording medium comprising a non-magnetic support having formed thereon a lower magnetic layer and an upper magnetic layer, wherein the upper magnetic layer has a thickness of from 0.05 to 0.70 μm, a residual magnetic susceptibility in the perpendicular direction of each of the lower magnetic layer and the upper magnetic layer and the number of laminated particles in the upper magnetic layer are specified.

JP-A-10-302243 discloses a magnetic recording medium comprising a support having formed thereon a magnetic layer composed mainly of a ferromagnetic powder and a binder, wherein the number of projections of 30 nm or more on the surface of the magnetic layer is not more than 100/900 μm², a magnetization reversal volume of the magnetic layer is from 0.1×10⁻¹⁷ to 5×10⁻¹⁷ mL, and an Hc of the magnetic layer is 2,000 Oe (160 kA/m) or more.

JP-A-11-39641 discloses a magnetic recording medium comprising a non-magnetic support having provided thereon a magnetic layer containing a ferromagnetic powder and a binder, wherein the ferromagnetic powder is a hexagonal ferrite powder having a mean particle size of not more than 0.3 μm and having the mean particle size twice as large as the thickness, and the hexagonal ferrite powder is uniformly dispersed in the magnetic layer.

### SUMMARY OF THE INVENTION

However, in the foregoing background art technologies, when combined with GMR head reproducing, there was still a room for improving the S/N characteristics.

Accordingly, an object of the invention is to provide a magnetic recording medium which is excellent in producibility and can be manufactured at low costs and which even when combined with GMR head reproducing, has a high output, a low noise, a high S/N ratio and excellent high-density characteristics.

The invention is as follows.

(1) A magnetic recording medium comprising a non-magnetic support having provided thereon a magnetic layer having a hexagonal ferrite dispersed in a binder, wherein the magnetic layer has a thickness of from 30 to −100 nm a coercive force Hc of from 3,000 to 4,200 Oe (from 240 to 336 kA/m), and a magnetization reversal volume of from 3×10⁻¹⁶ to 10×10⁻¹⁸ mL, and the hexagonal ferrite has a tabular ratio of from 2 to 3.

(2) The magnetic recording medium as set forth above in (1), wherein a non-magnetic layer having a non-magnetic powder dispersed in a binder is provided between the non-magnetic support and the magnetic layer.

According to the invention, it is possible to provide a magnetic recording medium which is excellent in producibility and can be manufactured at low costs and which even when combined with GMR head reproducing, has a high output, a low noise, a high S/N ratio and excellent high-density characteristics.

Incidentally, in almost all of the related-art magnetic recording media, the Hc is not more than 2,600 Oe (208 kA/m) For example, in JP-A-8-221740, while claim 1 recites that the Hc is from 1,500 to 6,000 Oe (from 120 to 480 kA/m), all of the magnetic recording media as produced in the working examples have an HC of not more than 2,600 Oe (208 kA/m).

### DETAILED DESCRIPTION OF THE INVENTION

The invention-will be described below in more detail.

<Hexagonal Ferrite>

Examples of the hexagonal ferrite which is used in the invention include barium ferrite, strontium ferrite, lead ferrite, calcium ferrite, and substituted bodies thereof with Co, etc. More specific examples thereof include magneto-plumbite type barium ferrite and strontium ferrite, magneto-plumbite type ferrite in which the particle surface is coated with spinel, and magnetoplumbite type barium ferrite and strontium ferrite partially containing a spinel phase. Besides, atoms such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, and Nb may be contained in addition to the prescribed atoms. In general, materials having elements (for example, Co—Zn, Co—Ti, Co—Ti—Zr, Co—Ti—Zn, Ni—Ti—Zn, Nb—Zn—Co, Sb—Zn—Co, and Nb—Zn) added thereto can be used. Also, there are some materials containing inherent impurities depending upon the raw material and production process.

The hexagonal ferrite of the invention is preferably Ba ferrite, and more preferably Ba ferrite having a ratio of Ba to Fe (Ba/Fe) of from 0.075 to 0.085. Incidentally, magnetic bodies containing a stoichiometric amount or more of Fe for the purpose of improving a saturation magnetization as have a high noise and are not suitable for the invention, the reasons of which are, however, unclear.

The hexagonal ferrite has a mean particle size of from 15 to 40 nm, and preferably from 18 to 35 nm and a tabular ratio {a mean value of (tabular size)/(tabular thickness)} of from 2 to 3, and preferably from 2 to 2.5. Though the particle of the hexagonal ferrite is in a hexagonal tabular form, by making the tabular ratio low in this way, packing properties of the particle increase; even when the magnetic layer is made thin, a reduction of the output is compensated; and the particle of the magnetic material per unit volume of the magnetic layer increases so that the noise can be reduced. Incidentally, the control of the tabular ratio can be achieved by changing a ratio between Fe and Ba constituting the particle.

Also, it is preferable that the hexagonal ferrite has a specific surface area as measured by the BET method of from 50 to 100 m²/g.

In general, it is preferable that the distribution of the particle tabular size/tabular thickness of the hexagonal ferrite is as narrow as possible. The particle tabular size/tabular thickness can be digitized by randomly measuring 500 particles by particle TEM photography. While the distribution of the particle tabular size/tabular thickness is often not a normal distribution, when measured and expressed in terms of a standard deviation against the mean size, (a/(mean size)) is from 0.1 to 2.0. In order to make the particle-size distribution sharp, not only the particle forming reaction system is made uniform as far as possible, but also the formed particles are subjected to a distribution improving treatment. For example, there are known a method for selectively dissolving an ultra-fine particle in an acid solution and other methods.

Examples of the production process of a hexagonal ferrite include (1) a glass crystallization method in which barium oxide, iron oxide and a metal oxide for substituting iron are mixed with a glass forming substance such as boron oxide so as to have a desired ferrite composition, the mixture is melted and then quenched to form an amorphous body, and then, the amorphous body is again heated, rinsed and pulverized to obtain a barium ferrite crystal powder; (2) a hydrothermal reaction method in which a barium ferrite composition metal salt solution is neutralized with an alkali, and after eliminating by-products, the liquid phase is heated at 100° C. or higher, followed by rinsing, drying and pulverization to obtain a barium ferrite crystal powder; and (3) a coprecipitation method in which a barium ferrite composition metal salt solution is neutralized with an alkali, and after eliminating by-products, the residue is dried and treated at not higher than 1,100° C., followed by pulverization to obtain a barium ferrite crystal powder. However, it should not be construed that the invention is limited to these methods. The hexagonal ferrite may be subjected to a surface treatment with Al, Si, P, or an oxide thereof as the need arises. That amount is from 0.1 to 10% by weight based on the hexagonal ferrite; and when subjected to a surface treatment, adsorption of a lubricant such as fatty acids becomes not more than 100 mg/m², and therefore, such is preferable. In some case, the hexagonal ferrite contains soluble inorganic ions of Na, Ca, Fe, Ni, Sr, etc. While it is substantially preferable that the hexagonal ferrite does not contain such soluble inorganic ions, if the content of the soluble inorganic ions is not more than 200 ppm, the characteristics are scarcely affected especially.

<Binder>

The binder which is used in the magnetic layer of the invention is a conventionally known thermoplastic resin, thermosetting resin or reaction type resin or a mixture thereof. Examples of the thermoplastic resin include polymers or copolymers containing, as a constituent unit, vinyl chloride, vinyl acetate, vinyl alcohol, maleic acid, acrylic acid, an acrylic ester, vinylidene chloride, acrylonitrile, methacrylic acid, a methacrylic ester, styrene, butadiene, ethylene, vinyl butyral, vinyl acetal, vinyl ether, or the like; polyurethane resins; and various rubber based resins.

Furthermore, examples of the thermosetting resin or reaction type resin include phenol resins, epoxy resins, polyurethane curable resins, urea resins, melamine resins, alkyd resins, acrylic reaction resins, form a ldehyde resins, silicone resins, epoxy-polyamide resins, mixtures of a polyester resin and an isocyanate prepolymer, mixtures of a polyester polyol and a polyisocyanate, and mixtures of a polyurethane and a polyisocyanate. All of the thermoplastic resin, the thermosetting resin and the reaction type resin are described in detail in Purasuchikku Handobukku (Plastic Handbook) (published by Asakura Shoten).

Moreover, when an electron beam-curable resin is used in the magnetic layer, not only the coating film strength is enhanced and the durability is improved, but also the surface is smoothed and the electromagnetic conversion characteristics are further enhanced. Examples and production process thereof are described in detail in JP-A-62-256219.

These resins can be used singly or in an embodiment of a combination thereof. Above all, it is preferred to use a polyurethane resin. Moreover, it is preferred to use a polyurethane resin prepared by not only reacting hydrogenated bisphenol A or a cyclic structure such as a polypropylene oxide adduct of hydrogenated bisphenol A, a polyol having an alkylene oxide chain and having a molecular weight of from 500 to 5,000, a polyol having a cyclic structure and having a molecular weight of from 200 to 500 as a chain extender, and an organic diisocyanate but also introducing a polar group; a polyurethane resin prepared by not only reacting a polyester polyol composed of an aliphatic dibasic acid (for example, succinic acid, adipic acid, and sebacic acid) and an aliphatic diol having an alkyl branched side chain and not having a cyclic structure (for example, 2,2-dimethyl-1,3-propanediol, 2-ethyl-2-butyl-1,3-propanediol, and 2,2-diethyl-1,3-propanediol), an aliphatic diol having a branched alkyl side chain having 3 or more carbon atoms (for example, 2-ethyl-2-butyl-1,3-propanediol and 2,2-diethyl-1,3-propanediol) as a chain extender, and an organic diisocyanate compound but also introducing a polar group; or a polyurethane resin prepared by not only reacting a cyclic structure such as a dimer diol, a polyol compound having a long-chain alkyl chain, and an organic diisocyanate but also introducing a polar group.

An average molecular weight of the polar group-containing polyurethane based resin which is used in the invention is preferably from 5,000 to 100,000, and more preferably from 10,000 to 50,000. What the average molecular weight is 5,000 or more is preferable because a reduction of physical strength such that the resulting magnetic coating film is brittle is not caused and the durability of the magnetic recording medium is not affected. Also, when the average molecular weight is not more than 100,000, since the solubility in a solvent is not lowered, the dispersibility is satisfactory. Moreover, since the viscosity of a coating material in a prescribed concentration does not increase, the workability is good, and the handling is easy.

Examples of the polar group which is contained in the foregoing polyurethane based resin include —COOM, —SO₃M, —OSO₃M, —P═O(OM)₂, —O—P═O(OM)₂ (wherein M represents a hydrogen atom or an alkali metal base), —OH, —NR₂, —N⁺R₃ (wherein R represents a hydrocarbon group), an epoxy group, —SH, and —CN; and those resulting from introduction of at least one of these polar groups by copolymerization or addition reaction can be used. Also, in the case where the polar group-containing polyurethane based resin has an OH group, it is preferred to have a branched OH group in view of curability and durability. The polar group-containing polyurethane based resin preferably has from 2 to 40 branched OH groups, and more preferably from 3 to 20 branched OH groups per molecule. Also, an amount of such a polar group is from 10⁻¹ to 10⁻⁸ moles/g, and preferably 10⁻² to 10⁻⁶ moles/g.

Specific examples of the binder include VAGH, VYHH, VMCH, VAGF, VAGD, VROH, VYES, VYNC, VMCC, XYHL, XYSG, PKHN, PKHJ, PKHC, and PKFE (all of which are manufactured by Union Carbide Corporation); MPR-TA, MPR-TA5, MPR-TAL, MPR-TSN, MPR-TMF, MPR-TS, MPR-TM, and MPR-TAO (all of which are manufactured by Nissin Chemical Industry Co., Ltd.); 1000W, DX80, DX81, DX82, DX83, and 100FD (all of which are manufactured by Denki Kagaku Kogyo K.K.); MR-104, MR-105, MR110, MR100, MR555, and 400X-110A (all of which are manufactured by Zeon Corporation); NIPPOLAN N2301, N2302 and N2304 (all of which are manufactured by Nippon Polyurethane Industry Co., Ltd.); PANDEX T-5105, R-R3080 and T-5201, BURNOCK D-400 and D-210-80, and CRISVON 6109 and 7209 (all of which are manufactured by Dainippon Ink and Chemicals, Incorporated); VYLON UR8200, UR8300, UR-8700, RV530 and RV280 (all of which are manufactured by Toyobo Co., Ltd.); DAIFERAMINE 4020, 5020, 5100, 5300, 9020, 9022 and 7020 (all of which are manufactured by Dainichiseika Color & Chemicals Mfg. Co., Ltd.); MX 5004 (manufactured by Mitsubishi Chemical Corporation); SANPRENE SP-150 (manufactured by Sanyo Chemical Industries, Ltd.); and SARAN F310 and F210 (all of which are manufactured by Asahi Kasei Corporation).

An addition amount of the binder which is used in the magnetic layer of the invention is in the range of from 5 to 50% by weight, and preferably from 10 to 30% by weight based on the weight of the hexagonal ferrite. In the case where the polyurethane resin or polyisocyanate is used, it is preferred to combine it within the range from 2 to 20% by weight, respectively and use it. However, for example, in the case where head corrosion occurs due to a very small amount of eliminated chlorine, it is possible to use only the polyurethane or only the polyurethane and the polyisocyanate. In the case of using a vinyl chloride based resin as other resin, the addition amount of the vinyl chloride based resin is preferably in the range of from 5 to 30% by weight. In the invention, in the case of using the polyurethane, it is preferable that its glass transition temperature is from −50 to 150° C., and preferably from 0 to 100° C.; that its breaking extension is from 100 to 2,000%; that its breaking stress is from 0.49 to 98 MPa (from 0.05 to 10 kg/nm²); and that its breakdown point is from 0.49 to 98 MPa (from 0.05 to 10 kg/mm²).

For example, in the case where the magnetic recording medium which is used in the invention is a floppy disk, it can be constructed of two or more layers on the both surfaces of a support. Accordingly, as a matter of course, the amount of the binder, the amount of the vinyl chloride based resin, the polyurethane resin, the polyisocyanate or other resins occupied in the binder, the molecular weight of each of the resins for forming the magnetic layer, the amount of the polar group, the physical characteristics of the resins as described above, and the like can be varied in the non-magnetic layer and the respective magnetic layers as the need arises. Rather, they must be optimized for the respective layers, and known technologies regarding multilayered magnetic layers can be applied. For example, in the case where the amount of the binder is changed in the respective layers, it is effective to increase the amount of the binder in the magnetic layer for the sake of reducing scratches on the surface of the magnetic layer. For the sake of making head touch against the head satisfactory, it is possible to bring flexibility by increasing the amount of the binder in the non-magnetic layer.

Examples of the polyisocyanate which can be used in the invention include isocyanates (for example, tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, and triphenylmethane triisocyanate); reaction products between such an isocyanate and a polyalcohol; and polyisocyanates formed by condensation of such an isocyanate. Among these isocyanates, examples of trade names of commercially available products include CORONATE L, CORONATE HL, CORONATE 2030, CORONATE 2031, MILLIONATE MR, and MILLIONATE MTL (all of which are manufactured by Nippon Polyurethane Industry Co., Ltd.); TAKENATE D-102, TAKENATE D-110N, TAKENATE D-200, and TAKENATE D-202 (all of which are manufactured by Takeda Pharmaceutical Company Limited); and DESMODUR L, DESMODUR IL, DESMODUR N, and DSEMODUR HL (all of which are manufactured by Sumika Bayer Urethane Co., Ltd.). These can be used singly or in combination of two or more kinds thereof while utilizing a difference in the curing reactivity in each layer.

In the magnetic layer in the invention, additives can be added as the need arises. Examples of the additives include an abrasive, a lubricant, a dispersant/dispersing agent, a fungicide, an antistatic agent, an antioxidant, a solvent, and carbon black. Examples of these additives include diamond fine particles, molybdenum disulfide, tungsten disulfide, graphite, boron nitride, graphite fluoride, silicone oils, polar group-containing silicones, fatty acid-modified silicones, fluorine-containing silicones, fluorine-containing alcohols, fluorine-containing esters, polyolefins, polyglycols, polyphenyl ethers, aromatic ring-containing organic phosphonic acids (for example, phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, and nonylphenylphosphonic acid) and alkali metal salts thereof, alkylphosphonic acids (for example, octylphosphonic acid, 2-ethylhexylphosphonic acid, isooctylphosphonic acid, isononylphosphonic acid, isodecylphosphonic acid, isoundecylphosphonic acid, isodecylphosphonic acid, isohexadecylphosphonic acid, isooctadecylphosphonic acid, and isoeicosylphosphonic acid) and alkali metal salts thereof, aromatic phosphoric esters (for example, phenyl phosphate, benzyl phosphate, phenethyl phosphate α-methylbenzyl phosphate, 1-methyl-1-phenethyl phosphate, diphenylmethyl phosphate, biphenyl phosphate, benzylphenyl phosphate, α-cumyl phosphate, toluyl phosphate, xylyl phosphate, ethylphenyl phosphate, cumenyl phosphate, propylphenyl phosphate, butylphenyl phosphate, heptylphenyl phosphate, octylphenyl phosphate, and nonylphenyl phosphate) and alkali metal salts thereof, alkyl phosphates (for example, octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, and isoeicosyl phosphate) and alkali metal salts thereof, alkyl sulfonates and alkali metal salts thereof, fluorine-containing alkyl sulfates and alkali metal salts thereof, monobasic fatty acids having from 10 to 24 carbon atoms, which may contain an unsaturated bond and may be branched (for example, lauric acid, myristic acid, palmitic acid, stearic acid, behenic acid, butyl stearate, oleic acid, lonoleic acid, linolenic acid, elaidic acid, and erucic acid) and metal salts thereof, mono-fatty acid esters, di-fatty acid esters or polyhydric fatty acid esters composed of a monobasic fatty acid having from 10 to 24 carbon atoms, which may have an unsaturated bond and may be branched, any one of a monohydric to hexahydric alcohol having from 2 to 22 carbon atoms, which may have an unsaturated bond and may be braned, an alkoxy alcohol having from 2 to 22 carbon atoms, which may have an unsaturated bond and may be branched, and a monoalkyl ether of an alkylene oxide polymer (for example, butyl stearate, octyl stearate, amyl stearate, isooctyl stearate, octyl myristate, butyl laurate, butoxyethyl stearate, anhydrosorbitan monostearate, and anhydrosorbitan tristearate), fatty acid amides having from 2 to 22 carbon atoms, and aliphatic amines having from 8 to 22 carbon atoms. Also, besides the foregoing hydrocarbon groups, those having an alkyl group, an aryl group, or an aralkyl group substituted with other group than a nitro group and hydrocarbon groups such as halogen-containing hydrocarbons (for example, F, Cl, Br, CF₃, CCl₃, and CBr₃) can be enumerated.

Furthermore, nonionic surfactants (for example, alkylene oxide based surfactants, glycerin based surfactants, glycidol based, and alkylphenol ethylene oxide adducts), cationic surfactants (for example, cyclic amines, ester amides, quaternary ammonium salts, hydantoin derivatives, heterocyclic compounds, phosphonium compounds, and sulfonium compounds), anionic surfactants containing an acidic group (for example, carboxylic acids, sulfonic acids, and sulfuric acid esters), and ampholytic surfactants (for example, amino acids, aminosulfonic acids, sulfuric acid or phosphoric acid esters of an amino alcohol, and alkylbetaine type surfactants) can be used. These surfactants are described in detail in Kaimen Kasseizai Binran (Surfactant Handbook) (published by Sangyo Tosho Publishing).

The foregoing lubricant, lubricant, etc. need not always be pure and may contain, in addition to the major components, impurities such as isomers, unreacted materials, by-products, decomposition products, and oxides. However, the content of these impurities is preferably not more than 30% by weight, and more preferably not more than 10% by weight.

Specific examples of these additives include NAA-102, hardened castor oil fatty acid, NAA-42, CATION SA, NYMEEN L-201, NONION E-208, ANON BF, and ANON LG (all of which manufactured by NOF Corporation); FAL-205 and FAL-123 (all of which are manufactured by Takemoto Oil & Fat Company); ENUJELV OL (manufactured by New Japan Chemical Co., Ltd.); TA-3 (manufactured by Shin-Etsu Chemical Co., Ltd.); ARMIDE P (manufactured by Lion Akzo Co., Ltd.); DUOMIN TDO (manufactured by Lion Corporation); BA-41G (manufactured by The Nisshin Oil Mills, Ltd.); and PROFAN 2012E, NEWPOL PE61, and IONET MS-400 (all of which are manufactured by Sanyo Chemical Industries, Ltd.).

Furthermore, it is possible to add carbon black in the magnetic layer in the invention as the need arises. Examples of the carbon black which can be used in the magnetic layer include furnace black for rubber, thermal black for rubber, carbon black for coloring, and acetylene black. The carbon black preferably has a specific surface area of from 5 to 500 m²/g, a DBP oil absorption of from 10 to 400 mL/100 g, a particle size of from 5 to 300 nm, a pH of from 2 to 10, a water content of from 0.1 to 10%, and a tap density of from 0.1 to 1 g/mL.

Specific examples of the carbon black which is used in the invention include BLACKPEARLS 2000, 1300, 1000, 900, 905, 800 and 700 and VULCAN XC-72 (all of which are manufactured by Cabot Corporation); #80, #60, #55, #50, and #35 (all of which are manufactured by Asahi Carbon Co., Ltd.); #2400B, #2300, #900, #1000, #30, #40, and #10B (all of which are manufactured by Mitsubishi Chemical Corporation); CONDUCTEX SC, RAVEN 150, 50, 40 and 15, and RAVEN-MT-P (all of which are manufactured by Columbian Carbon Co.); and Ketjen Black EC (manufactured by Nippon EC K.K.). The carbon black may be subjected to a surface treatment with a dispersant, etc. or grafting with a resin, or a part of the surface of the carbon black may be subjected to graphitization. Also, the carbon black may be dispersed with a binder in advance prior to addition to a magnetic coating material. The carbon black can be used singly or in combination. In the case where the carbon black is used, it is preferred to use the carbon black in an amount of from 0.1 to 30% by weight based on the weight of the hexagonal ferrite. The carbon black has functions of preventing static charging of the magnetic layer, reducing a coefficient of friction, imparting light-shielding properties, and enhancing a film strength. Such functions vary depending upon the type of carbon black to be used. Accordingly, with respect to the carbon black which is used in the invention, it is, as a matter of course, possible to change and choose the type, the amount and the combination for the magnetic layer and the non-magnetic layer according to the intended purpose based on the previously mentioned various characteristics such as particle size, oil absorption, electric conductivity, and pH, and rather, they should be optimized for the respective layers. The carbon black which can be used in the magnetic layer of the invention can be referred to, for example, Kabon Burakku Binran (Carbon Black Handbook) (edited by The Carbon Black Association of Japan).

As an organic solvent which is used in the invention, known organic solvents can be used. As the organic solvent which is used in the invention, a ketone (for example, acetone, methyl ethyl ketone, methyl isobutyl ketone, diisobutyl ketone, cyclohexanone, isophorone, and tetrahydrofuran), an alcohol (for example, methanol, ethanol, propanol, butanol, isobutyl alcohol, isopropyl alcohol, and methylcyclohexanol), an ester (for example, methyl acetate, butyl acetate, isobutyl acetate, isopropyl acetate, ethyl lactate, and glycol acetate), a glycol ether (for example, glycol dimethyl ether, glycol monoethyl ether, and dioxane), an aromatic hydrocarbon (for example, benzene, toluene, xylene, cresol, and chlorobenzene), a chlorohydrocarbon (for example, methylene chloride, ethylene chloride, carbon tetrachloride, chloroform, ethylene chlorohydrin, and dichlorobenzene), N,N-dimethylformamide, hexane, or the like can be used at any ratio.

These organic solvents need not always be 100% pure and may contain, in addition to the major components, impurities such as isomers, unreacted materials, by-products, decomposition products, oxides, and moisture. The content of these impurities is preferably not more than 30% by weight, and more preferably not more than 10% by weight. The organic solvent which is used in the invention is preferably the same type for both the magnetic layer and the non-magnetic layer. However, the addition amount of the organic solvent may be varied. When a solvent having a high surface tension (for example, cyclohexanone and dioxane) is used in the non-magnetic layer, the coating stability is enhanced; and more specifically, it is important that an arithmetic mean value of the solvent composition of the upper layer is not lower than an arithmetic mean value of the solvent composition of the non-magnetic layer. In order to enhance the dispersibility, it is preferable that the polarity is somewhat strong, and the solvent composition preferably contains 50% or more of a solvent having a dielectric constant of 15 or more. Also, the solubility parameter is preferably from 8 to 11.

The type and the amount of the dispersant, lubricant and surfactant which are used in the invention can be changed in the magnetic layer and the non-magnetic layer as described later as the need arises. For example, although not limited only to the examples as described herein, the dispersant has properties of adsorbing or bonding via the polar group, and it is assumed that the dispersant adsorbs or bonds, via the polar group, mainly to the surface of the hexagonal ferrite in the magnetic layer and mainly to the surface of the non-magnetic powder in the non-magnetic layer, for example, an organophosphorus compound having been once adsorbed is hardly desorbed from the surface of a metal or metal compound, etc. Accordingly, since in the invention, the surface of the hexagonal ferrite or the surface of the non-magnetic powder is in a state that it is covered by an alkyl group, an aromatic group, etc., the affinity of the hexagonal ferrite or the non-magnetic powder with the binder resin component is enhanced, and further, the dispersion stability of the hexagonal ferrite or the non-magnetic powder is also improved. With respect to the lubricant, since it is present in a free state, its exudation to the surface is controlled by using fatty acids having a different melting point for the non-magnetic layer and the magnetic layer or by using esters having a different boiling point or polarity. The coating stability can be improved by regulating the amount of the surfactant, and the lubricating effect can be enhanced by increasing the amount of the lubricant to be added in the non-magnetic layer. Also, all or a part of the additives which are used in the invention may be added in any stage at the time of preparing a coating solution for magnetic layer or non-magnetic layer. For example, they may be mixed with the hexagonal ferrite prior to the kneading step; they may be added in the kneading step by the hexagonal ferrite, the binder and the solvent; they may be added during the dispersing step; they may be added after the dispersing step; or they may be added immediately before coating.

In the invention, the magnetic layer has an Hc of from 3,000 Oe to 4,200 Oe (from 240 to 336 kA/m), and preferably from 3,200 Oe to 4,000 Oe (from 256 to 320 kA/m). Incidentally, the Hc can be controlled according to the particle size (tabular size/tabular thickness) of the hexagonal ferrite, the kind and amount of elements to be contained, the substitution site of element, the particle forming reaction conditions, and the like. When the Hc is high, high-density recording can be achieved, but there are restrictions by the head. When the Hc is less than 3,000 Oe, high-density recording cannot be achieved. When the Hc exceeds 4,200 Oe, there are restrictions by the head, whereby recording cannot be satisfactorily achieved. Also, since when the magnetic layer is remote from the head, a magnetic field becomes weak, it is preferable that the magnetic layer is thin. For that reason in the invention, a thickness of the magnetic layer is set up at from 30 nm to 100 nm, and preferably from 40 nm to 80 nm. When the thickness of the magnetic layer is less than 30 nm, an output is too low so that high-density recording cannot be achieved. When the thickness of the magnetic layer exceeds 100 nm, there is caused a problem in overwrite characteristics. In general, when the thickness of the magnetic layer is thin in this way, magnetization per the area of the medium is reduced, and therefore, an output is lowered. However, according to the invention, since the tabular ratio of the hexagonal ferrite is set up at from 2 to 3 as described above, packing properties of the particle increase; even when the magnetic layer is made thin, a reduction of the output is compensated; and the magnetic particle per unit volume of the magnetic layer increases so that the noise can be reduced.

A packing density of the hexagonal ferrite in the magnetic layer is 2.4 g/mL or more, preferably 2.5 g/mL or more, and more preferably from 2.6 to 3.0 g/mL. The packing density is affected by a formulation of the magnetic layer. In particular, for the purpose of increasing the packing density, it is preferred to use, as an abrasive, a diamond fine particle having a mean particle size of from 30 to 200 μm in an amount of from 1 to 5 parts by weight based on 100 parts by weight of the hexagonal ferrite.

Furthermore, in the invention, by setting up a magnetization reversal volume of the magnetic layer at from 1×10⁻¹⁸ to 10×10⁻¹⁸ mL, the noise can be further reduced. The magnetization reversal volume is preferably from 3×10⁻¹⁸ to 10×10⁻¹⁸ mL. When the magnetization reversal volume is less than 1×10⁻¹⁸ mL, there is caused a problem in the stability of magnetization due to thermal fluctuation, while when it exceeds 10×10⁻¹⁸ mL, the noise becomes large so that such is not suitable for high-density recording.

A magnetization reversal volume V of the magnetic layer in the invention can be determined according to the following expression. A magnetic field sweep rate of the Hc measurement portion is measured at 5 minutes and 30 minutes by using a vibration sample magnetometer (VSM), and V is determined according to the following relational expression between the Hc due to thermal fluctuation and the magnetization reversal volume V.
Hc=(2K/Ms){1−[(kT/KV)ln(At/0.693)]^{1/2}}

In the expression, K represents an anisotropic constant; Ms represents a saturation magnetization; k represents a Boltzmann's constant; T represents an absolute temperature; V represents a magnetization reversal volume; A represents a spin precession frequency; and t represents a magnetic field reversal time. The magnetization reversal volume V can be controlled by regulating the magnetic characteristics and alignment in the magnetic layer, regulating a squareness ratio (SQ) in the plane, or highly dispersing the hexagonal ferrite, or by other means. Although the SQ is preferably 0.6 or more, in the case of manufacturing a magnetic disk, it is impossible to achieve an in-plane alignment treatment because of a problem of modulation.

[Non-Magnetic Layer]

Next, the detail contents regarding the non-magnetic layer will be described below. The magnetic recording medium of the invention can have a non-magnetic layer containing a binder and a non-magnetic powder between the non-magnetic support and the magnetic layer. The non-magnetic powder which can be used in the non-magnetic layer may be an inorganic substance or an organic substance. Also, carbon black or the like can be used. Examples of the inorganic substance include metals, metal oxides, metal carbonates, metal sulfates, metal nitrides, metal carbides, and metal sulfides.

Specific examples thereof include titanium oxides (for example, titanium dioxide), cerium oxide, tin oxide, tungsten oxide, ZnO, ZrO₂, SiO₂, Cr₂O₃, α-alumina having an α-component proportion of from 90 to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide. They are used singly or in combination of two or more kinds thereof. Of these, α-iron oxide and titanium oxide are preferable.

The form of the non-magnetic powder may be any one of acicular, spherical, polyhedral, or tabular. A crystallite size of the non-magnetic powder is preferably from 4 nm to 1 μm, and more preferably from 40 to 100 nm. What the crystallite size falls within the range of from 4 nm to 1 μm is preferable because not only the dispersion does not become difficult, but also a suitable surface roughness is obtained. While a mean particle size of such a non-magnetic powder is preferably from 5 nm to 2 μm, it is possible to bring the same effect by combining non-magnetic powders having a different mean particle size, if desired or widening the particle size distribution of even a single non-magnetic powder. The mean particle size of the non-magnetic powder is especially preferably from 10 to 200 nm. What the mean particle size of the non-magnetic powder falls within the range of from 5 nm to 2 μm is preferable because not only dispersion is satisfactory, but also a suitable surface roughness is obtained.

A specific surface area of the non-magnetic powder is from 1 to 100 m²/g, preferably from 5 to 70 m²/g, and more preferably from 10 to 65 m²/g. What the specific surface area falls within the range of from 1 to 100 m²/g is preferable because not only a suitable surface roughness is obtained, but also dispersion can be carried out with a desired amount of the binder. An oil absorption using dibutyl phthalate (DBP) is from 5 to 100 mL/100 g, preferably from 10 to 80 mL/100 g, and more preferably from 20 to 60 mL/100 g. A specific gravity is from 1 to 12, and preferably from 3 to 6. A tap density is from 0.05 to 2 g/mL, and preferably from 0.2 to 1.5 g/mL. When the tap density is in the range of from 0.05 to 2 g/mL, there is little scattering of particles, the operation is easy, and the non-magnetic power tends to hardly stick to a device. Though a pH of the non-magnetic powder is preferably from 2 to 11, the pH is especially preferably from 6 to 9. When the pH is in the range of from 2 to 11, a coefficient of friction does not become large at a high temperature and a high humidity or by liberation of a fatty acid. A water content of the non-magnetic powder is from 0.1 to 5% by weight, preferably from 0.2 to 3% by weight, and more preferably from 0.3 to 1.5% by weight. What the water content falls within the range of from 0.1 to 5% by weight is preferable because not only dispersion is satisfactory, but also the viscosity of the coating material after dispersion becomes stable. An ignition loss is preferably not more than 20% by weight, and a small ignition loss is preferable.

Furthermore, in the case where the non-magnetic powder is an inorganic powder, its Mohs hardness is preferably from 4 to 10. When the Mohs hardness is in the range of from 4 to 10, it is possible to ensure durability. The non-magnetic powder preferably has an absorption of stearic acid of from 1 to 20 mmoles/m², and more preferably from 2 to 15 pmoles/m². It is preferable that the non-magnetic powder has heat of wetting in water at 25° C. in the range of from 200 to 600 erg/cm² (from 200 to 600 mJ/m²). Also, it is possible to use a solvent whose heat of wetting falls within this range. The number of water molecules on the surface at from 100 to 400° C. is suitably from 1 to 10 per 100 angstrom. The pH at an isolectric point in water is preferably from 3 to 9. Itis preferable that Al₂O₃, SiO₂, TiO₂, ZrO₂, SnO₂, Sb₂O₃, or ZnO is present on the surface of the non-magnetic powder through a surface treatment. In particular, Al₂O₃, SiO₂, TiO₂, and ZrO₂ are preferable for the dispersibility, with Al₂O₃, SiO₂ and ZrO₂ being more preferable. They may be used in combination or can be used singly. Furthermore, depending upon the intended purpose, a surface-treated layer resulting from coprecipitation may be used. There may be employed a method in which the surface is first treated with alumina and the surface layer is then treated with silica, or vice versa. Moreover, though the surface-treated layer may be made of a porous layer depending upon the intended purpose, it is generally preferable that the surface-treated layer is uniform and dense.

Specific examples of the non-magnetic powder which is used in the non-magnetic layer of the invention include NONATITE (manufactured by Showa Denko K.K.); HIT-100 and ZA-G1 (all of which are manufactured by Sumitomo Chemical Co., Ltd.); DPN-250, DPN-250BX, DPN-245, DPN-270BX, DPB-550BX, and DPN-550RX (all of which are manufactured by Toda Kogyo Corp.); titanium oxides TTO-51B, TTO-55A, TTO-55B, TTO-55C, TTO-55S, TTO-55D, SN-100 and MJ-7 and α-iron oxides E270, E271 and E300 (all of which are manufactured by Ishihara Sangyo Kaisha, Ltd.); STT-4D, STT-30D, STT-30, and STT-65C (all of which are manufactured by Titan Kogyo Kabushiki Kaisha); MT-100S, MT-100T, MT-150W, MT-500B, T-600B, T-100F, and T-500HD (all of which are manufactured by Tayca Corporation); FINEX-25, BF-1, BF-10, BF-20, and ST-M (all of which are manufactured by Sakai Chemical Industry Co., Ltd.); DEFIC-Y and DEFIC-R (all of which are manufactured by Dowa Mining Co., Ltd.); AS2BM and TiO2P25 (all of which are manufactured by Nippon Aerosil Co., Ltd.); 100A and 500A (all of which are manufactured by Ube Industries, Ltd.); and Y-LOP (manufactured by Titan Kogyo Kabushiki Kaisha) and calcined products thereof. Of these, titanium dioxide and α-iron oxide are especially preferable as the non-magnetic powder.

By mixing carbon black with the non-magnetic powder, not only the surface electrical resistance of the non-magnetic layer can be reduced and light transmittance can be decreased, but also a desired micro-Vickers hardness can be obtained. Though the micro-Vickers hardness of the non-magnetic layer is usually from 25 to 60 kg/mm² (from 245 to 588 MPa), for the purpose of adjusting the head contact, it is preferably from 30 to 50 kg/mm² (from 294 to 490 MPa). The micro-Vickers hardness can be measured by using a thin film hardness meter (HMA-400, manufactured by NEC Corporation) with, as an indenter tip, a triangular pyramidal diamond needle having a tip angle of 80° and a tip radius of 0.1 μm. The light transmittance is generally standardized such that absorption of infrared rays having a wavelength of approximately 900 nm is not more than 3% and for example, in the case of VHS magnetic tapes, is not more than 0.8%. For achieving this, furnace black for rubber, thermal black for rubber, carbon black for coloring, acetylene black, and the like can be used.

The carbon black which is used in the non-magnetic layer of the invention has a specific surface area of from 100 to 500 m²/g, and preferably from 150 to 400 m²/g and a DBP oil absorption of from 20 to 400 mL/100 g, and preferably from 30 to 200 mL/100 g. The carbon black has a particle size of from 5 to 80 nm, preferably from 10 to 50 nm, and more preferably from 10 to 40 nm. The carbon black preferably has a pH of from 2 to 10, a water content of from 0.1 to 10%, and a tap density of from 0.1 to 1 g/mL.

Specific examples of the carbon black which can be used in the non-magnetic layer of the invention include BLACKPEARLS 2000, 1300, 1000, 900, 800, 880 and 700 and VULCAN XC-72 (all of which are manufactured by Cabot Corporation); #3050B, #3150B, #3250B, #3750B, #3950B, #950, #650B, #970B, #850B, and MA-600 (all of which are manufactured by Mitsubishi Chemical Corporation); CONDUCTEX SC and RAVEN 8800, 8000, 7000, 5750, 5250, 3500, 2100, 2000, 1800, 1500, 1255 and 1250 (all of which are manufactured by Columbian Carbon Co.); and Ketjen Black EC (manufactured by Akzo Nobel).

Furthermore, those processed by subjecting carbon black to a surface treatment with a dispersant, etc. or grafting with a resin, or by graphitizing a part of the surface thereof may be used. Also, prior to adding carbon black to a coating material, the carbon black may be previously dispersed with a binder. The carbon black can be used within the range not exceeding 50% by weight based on the foregoing inorganic powder and within the range not exceeding 40% by weight of the total weight of the non-magnetic layer. The carbon black can be used singly or in combination. The carbon black which can be used in the non-magnetic layer of the invention can be referred to, for example, Kabon Burakku Binran (Carbon Black Handbook) (edited by The Carbon Black Association of Japan).

Furthermore, it is possible to add an organic powder in the non-magnetic layer depending upon the intended purpose. Examples of such an organic powder include acrylic styrene based resin powders, benzoguanamine resin powders, melamine based resin powders, and phthalocyanine based pigments. Polyolefin based resin powders, polyester based resin powders, polyamide based resin powders, polyimide based resin powders, and polyfluoroethylene resins can also be used. As production methods thereof, those as described in JP-A-62-18564 and JP-A-60-255827 are employable.

With respect to the binder resin, lubricant, dispersant, additives, solvent, dispersion method and others of the non-magnetic layer, those in the magnetic layer can be applied. In particular, with respect to the amount and kind of binder resin and the addition amount and kind of additives and dispersant, known technologies regarding the magnetic layer can be applied.

Furthermore, the magnetic recording medium of the invention may be provided with an undercoat layer. By providing the undercoat layer, it is possible to enhance an adhesive strength between the support and the magnetic layer or non-magnetic layer. As the undercoat layer, a polyester resin which is soluble in a solvent is used.

[Layer Construction]

In the thickness construction of the magnetic recording medium which is used in the invention, a preferred thickness of the support is from 3 to 80 μm. Furthermore, in the case where an undercoat layer is provided between the support and the non-magnetic layer or magnetic layer, a thickness of the undercoat layer is from 0.01 to 0.8 μm, and preferably from 0.02 to 0.6 μm.

As described previously, thought the thickness of the magnetic layer is from 30 to 100 nm, it is optimized according to the saturation magnetization amount and the head gap length of the magnetic head to be used and a band of recording signals. Also, a rate of fluctuation in thickness of the magnetic layer is preferably within ±50%, and more preferably within ±40%. The magnetic layer may be made of at least one layer. However, the magnetic layer may be separated into two or more layers having different magnetic characteristics, and a known configuration for multilayered magnetic layers can be applied.

The non-magnetic layer of the invention has a thickness of from 0.5 to 2.0 μm, preferably from 0.8 to 1.5 μm, and more preferably from 0.8 to 1.2 μm. Incidentally, the non-magnetic layer of the magnetic recording medium of the invention exhibits its effect so far as it is substantially non-magnetic. For example, even when it contains a small amount of magnetic substance as an impurity or intentionally, if the effects of the invention can be revealed, such construction can be considered to be substantially the same as that of the magnetic recording medium of the invention. Incidentally, the terms “substantially the same” mean that the non-magnetic layer has a residual magnetic flux density of not more than 10 mT or a coercive force of not more than 8 kA/m (100 Oe), and preferably has neither residual flux density nor coercive force.

[Production Method]

A process for producing a coating solution for magnetic layer of the magnetic recording medium which is used in the invention comprises at least a kneading step, a dispersing step, and optionally, a mixing step that is carried out before or after the preceding steps. Each of the steps may be separated into two or more stages. All of the raw materials which are used in the invention, including the hexagonal ferrite, non-magnetic powder, binder, carbon black, abrasive, antistatic agent, lubricant and solvent, may be added in any step from the beginning or in the way of the step. Also, each of the raw materials may be divided and added across two or more steps. For example, a polyurethane may be divided and added in the kneading step, the dispersing step, and the mixing step for adjusting the viscosity after dispersion. In order to achieve the object of the invention, a conventionally known production technology can be employed as a part of the steps. In the kneading step, it is preferred to use a machine having a strong kneading power, such an open kneader, a continuous kneader, a pressure kneader, and an extruder. When the kneader is used, all or a part of the magnetic powder or non-magnetic layer and the binder (preferably 30% or more of the entire binders) are kneaded in an amount in the range of from 15 to 500 parts by weight based on 100 parts by weight of the magnetic powder. Details of these kneading treatments are described in JP-A-1-106338 and JP-A-1-79274. Also, for the sake of dispersing a solution for magnetic layer or a solution for non-magnetic layer, glass beads can be used. As such glass beads, dispersing media having a high specific gravity, such as zirconia beads, titania beads, and steel beads, are suitable. These dispersing media are used after optimizing the particle size and packing ratio. Known dispersion machines can be used.

According to the process for producing the magnetic recording medium of the invention, for example, a coating solution for magnetic layer is coated in a prescribed film thickness on the surface of a support under running, thereby forming a magnetic layer. Here, plural coating solutions for magnetic layer may be subjected to multilayer coating sequentially or simultaneously, and a coating solution for non-magnetic layer and a coating solution for magnetic layer may be subjected to multilayer coating sequentially or simultaneously. As a coating machine for coating the foregoing coating solution for magnetic layer or coating layer for non-magnetic layer, an air doctor coater, a blade coater, a rod coater, an extrusion coater, an air knife coater, a squeegee coater, a dip coater, a reverse roll coater, a transfer roll coater, a gravure coater, a kiss coater, a cast coater, a spray coater, a spin coater, and the like can be used. With respect to these, for example, Saishin Kothingu Gijutsu (Latest Coating Technologies) (May 31, 1983) (published by Sogo Gijutsu Center) can be referred to.

In the case of a magnetic tape, the coated layer of the coating solution for magnetic layer is subjected to a magnetic field alignment treatment of the hexagonal ferrite contained in the coated layer of the coating solution for magnetic layer in the longitudinal direction by using cobalt magnet or a solenoid. In the case of a disk, although sufficient isotropic alignment can sometimes be obtained in a non-alignment state without using an alignment device, it is preferred to use a known random alignment device by, for example, obliquely and alternately arranging cobalt magnet or applying an alternating magnetic field with a solenoid. The “isotropic alignment” as referred to herein means that, in the case of a hexagonal ferrite, in general, in-plane two-dimensional random is preferable, but it can be three-dimensional random by introducing a vertical component. In the case of a hexagonal ferrite, in general, it tends to be in-plane and vertical three-dimensional random, but in-plane two-dimensional random is also possible. By employing a known method using a heteropolar facing magnet so as to make vertical alignment, it is also possible to impart isotropic magnetic characteristics in the circumferential direction. In particular, in the case of carrying out high-density recording, vertical alignment is preferable. Furthermore, it is possible to carry out circumferential alignment using spin coating.

It is preferable that the drying position of the coating film can be controlled by controlling the temperature and blowing amount of dry air and the coating rate. The coating rate is preferably from 20 m/min to 1,000 m/min; and the temperature of the dry air is preferably 60° C. or higher. It is also possible to carry out preliminary drying in a proper level prior to entering a magnet zone.

After drying, the coated layer is usually subjected to a surface smoothing treatment. For the surface smoothing treatment, for example, super calender rolls, etc, are employed. By carrying out the surface smoothing treatment, cavities as formed by removal of the solvent at the time of drying disappear, whereby the packing ratio of the hexagonal ferrite in the magnetic layer is enhanced. Thus, a magnetic recording medium having high electromagnetic conversion characteristics is obtained. As the rolls for calender treatment, rolls of a heat-resistant plastic such as epoxy, polyimide, polyamide, and polyamideimide resins are used. It is also possible to carry out the treatment using metal rolls.

It is preferable that the magnetic recording medium of the invention has a surface having extremely excellent smoothness such that a surface center plane average roughness is in the range of from 0.1 to 4 nm, and preferably from 1 to 3 nm in a cutoff value of 0.25 mm. As a method therefor, for example, a magnetic layer as formed by selecting a specific hexagonal ferrite and a binder as described above is subjected to the foregoing calender treatment. The calender rolls are preferably actuated under such conditions that the calender roll temperature is in the range of from 60 to 100° C., preferably from 70 to 100° C., and especially preferably from 80 to 100° C.; and that the pressure is in the range of from 100 to 500 kg/cm (from 98 to 490 kN/m), preferably from 200 to 450 kg/cm (from 196 to 441 kN/m), and especially preferably from 300 to 400 kg/cm (from 294 to 392 kN/m).

The resulting magnetic recording medium can be cut into a desired size by using a cutter, etc. and used. The cutter is not particularly limited, but one in which a plurality of pairs of rotating upper blade (male blade) and lower blade (female blade) are provided is preferable. A slit speed, a working depth, a circumferential speed ratio of upper blade (male blade) and lower blade (female blade) {(upper blade circumferential speed)/(lower blade circumferential speed)}, a period of time of continuous use of slit blades, and so on are properly selected.

[Physical Properties]

The magnetic layer of the magnetic recording medium which is used in the invention preferably has a saturation magnetic flux density of from 100 to 300 mT. SFD and SFDr are preferably not more than 0.6, and more preferably not more than 0.2, respectively.

A coefficient of friction of the magnetic recording medium which is used in the invention against a head is not more than 0.5, and preferably not more than 0.3 at a temperature in the range of from −10 to 40° C. and at a humidity in the range of from 0 to 95%. A surface specific resistivity is preferably from 10⁴ to 10¹² Ω/sq on the magnetic surface; and an electrostatic potential is preferably from −500 V to +500 V. The magnetic layer preferably has a modulus of elasticity at an elongation of 0.5% of from 0.98 to 19.6 GPa (from 100 to 2,000 kg/mm²) in each direction within the plane and preferably has a breaking strength of from 98 to 686 MPa (from 10 to 70 kg/mm²); and the magnetic recording medium preferably has a modulus of elasticity of from 0.98 to 14.7 GPa (from 100 to 1,500 kg/mm²) in each direction within the plane, preferably has a residual elongation of not more than 0.5%, and preferably has a thermal shrinkage at any temperature of not higher than 100° C. of not more than 1%, more preferably not more than 0.5%, and most preferably not more than 0.1%.

The magnetic layer preferably has a glass transition temperature (the maximum point of a loss elastic modulus in a dynamic viscoelasticity measurement at 110 Hz) of from 50 to 180° C.; and the non-magnetic layer preferably has a glass transition temperature of from 0 to 180° C. The loss elastic modulus is preferably in the range of from 1×10⁷ to 8×10⁸ Pa (from 1×10⁸ to 8×10⁹ dyne/cm²); and a loss tangent is preferably not more than 0.2. When the loss tangent is too large, a sticking fault likely occurs. It is preferable that these thermal characteristics and mechanical characteristics are substantially identical within 10% in each direction in the plane of the medium.

The residual solvent to be contained in the magnetic layer is preferably not more than 100 mg/m², and more preferably not more than 10 mg/m². A porosity of the coated layer is preferably not more than 30% by volume, and more preferably not more than 20% by volume in both the non-magnetic layer and the magnetic layer. In order to achieve a high output, the porosity is preferably small, but there is some possibility that a certain value should be maintained depending upon the intended purpose. For example, in the case of a disk medium where repetitive use is considered to be important, a large porosity is often preferable in view of running durability.

It is preferable that the magnetic layer has a maximum height SRₘₐₓ of not more than 0.5 μm, a ten-point average roughness SRz of not more than 0.3 μm, a central surface peak height SRp of not more than 0.3 μm, a central surface valley depth SRv of not more than 0.3 μm, a central surface area factor SSr of from 20 to 80%, and an average wavelength Sλa of from 5 to 300 μm. These properties can be easily controlled by controlling the surface properties of the support by a filler, the shape of the roll surface in the calender treatment, and so on. It is preferable that the curl is within ±3%.

In the case where the magnetic recording medium of the invention is constructed of the non-magnetic layer and the magnetic layer, it is possible to vary these physical characteristics in the non-magnetic layer and the magnetic layer depending upon the intended purpose. For example, by increasing the modulus of elasticity of the magnetic layer, thereby enhancing the durability, it is possible to simultaneously make the modulus of elasticity of the non-magnetic layer lower than that of the magnetic layer, thereby improving the head contact of the magnetic recording medium.

### EXAMPLES

The invention will be further described below with reference to the following Examples and Comparative Examples, but it should not be construed that the invention is limited to these examples. Incidentally, all parts are a part by weight.

<Preparation of Coating Material for Magnetic Disk>

Magnetic Coating Material

| | | |
|---|---|---|
| Barium ferrite magnetic powder (magnetic material | 100 | parts |
| as shown in Table 1): | | |
| Polyurethane resin: | 12 | parts |
| Weight average molecular weight: 10,000 | | |
| Sulfonic acid functional group: 0.5 meq/g | | |
| Diamond fine particle (mean particle size: 0.10 μm): | 2 | parts |
| Carbon black (particle size: 0.015 μm): | 0.5 | parts |
| #55 (manufactured by Asahi Carbon Co., Ltd.) | | |
| Stearic acid: | 1.0 | part |
| Butyl stearate: | 2 | parts |
| Methyl ethyl ketone: | 180 | parts |
| Cyclohexanone: | 100 | parts |

Non-Magnetic Coating Material

| | | |
|---|---|---|
| Non-magnetic power, α-iron oxide: | 100 | parts |
| Mean primary particle size: 0.09 μm | | |
| Specific surface area as measured by the BET | | |
| method: 50 m²/g | | |
| pH: 7 | | |
| DBP oil absorption: 27 to 38 mL/100 g | | |
| Surface-treated layer, Al₂O₃: 8% by weight | | |
| Carbon black: | 25 | parts |
| CONDUCTEX SC-U (manufactured by Columbian | | |
| Carbon Co.) | | |
| Vinyl chloride copolymer: | 13 | parts |
| MR104 (manufactured by Zeon Corporation) | | |
| Polyurethane resin: | 5 | parts |
| UR8200 (manufactured by Toyobo Co., Ltd.) | | |
| Phenylphosphonic acid: | 3.5 | parts |
| Butyl stearate: | 1 | part |
| Stearic acid: | 2 | parts |
| Methyl ethyl ketone: | 205 | parts |
| Cyclohexanone: | 135 | parts |

With respect to each of the foregoing coating materials, the respective components were kneaded by a kneader. The kneaded mixture was fed into a lateral sand mill charged with 1.0-mmφ zirconia beads in an amount of 65% by volume based on the volume of the dispersing portion by means of a pump and dispersed at 2,000 rpm for 120 minutes (a period of time at which the mixture was substantially retained). With respect to the resulting dispersion, 6.5 parts of a polyisocyanate was added to the coating material for non-magnetic layer, and 2.5 parts of a polyisocyanate was added to the coating material for magnetic layer, respectively. For the coating material for magnetic layer, 7 parts of methyl ethyl ketone was further added. Each of the mixtures was filtered by a filter having a mean pore size of 1 μm, thereby preparing a coating solution for forming a non-magnetic layer and a coating solution for forming a magnetic layer, respectively.

The resulting coating solution for forming a non-magnetic layer was coated on a 52 μm-thick polyethylene terephthalate base in a thickness after drying of 1.5 μm and dried. Thereafter, the coating solution for forming a magnetic layer was subjected to sequential multilayer coating in a thickness of the magnetic layer of 80 nm. After drying, the coated material was subjected to 7-stage calendaring at a temperature of 90° C. and at a linear pressure of 300 kg/cm (294 kN/m). These operations were applied to the both surfaces of a non-magnetic support. The resulting material was punched into a size of 3.5 inches and subjected to a surface abrasion treatment, thereby obtaining disk media Nos. 1, 2, 3, 6, 7, 8, 9, 10, 11 and 12. A medium No. 4 was prepared in the same manner as described above, except that the dispersing time in the lateral sand mill was changed to 300 minutes (a period of time at which the mixture was substantially retained). Media Nos. 5, 13 and 14 were also prepared in the same manner as described above, except that sequential multilayer coating was carried out by using the coating solution of the medium No. 2 so as to have a thickness of the magnetic layer of 40 nm, 20 nm and 120 nm, respectively. A medium No. 15 was prepared in the same manner as described above, except that the dispersing time in the lateral sand mill was changed to 300 minutes (a period of time at which the mixture was substantially retained) and that sequential multilayer coating was carried out so as to have a thickness of the magnetic layer of 60 nm.

With respect to the resulting magnetic recording media, the following measurements were carried out.

(1) Magnetic Characteristics (Hc and SQ):

The Hc and SQ were measured at a magnetic field strength of 15 kOe (1,200 kA/m) by using a vibration sample magnetometer (manufactured by Toei Industry Co., Ltd.).

(2) Tabular Size and Tabular Ratio:

The tabular size and tabular thickness were measured with respect to 500 particles from a photograph captured by a transmission electron microscope, and average values of the tabular size and tabular ratio were employed.

(3) Ba/Fe:

The magnetic material was dissolved in hydrochloric acid, and concentrations of Ba and Fe were measured by ICP. The Ba/Fe was expressed in terms of an atomic ratio.

(4) Magnetization Reversal Volume:

A magnetic field sweep rate of the Hc measurement portion was measured at 5 minutes and 30 minutes by using VSM (manufactured by Toei Industry Co., Ltd.), and the magnetization reversal volume was calculated according to the following relational expression between the Hc due to thermal fluctuation and the magnetization reversal volume.
Hc=(2K/Ms){1−[(kT/KV)ln(At/0.693)]^{1/2}}

In the expression, K represents an anisotropic constant; Ms represents a saturation magnetization; k represents a Boltzmann's constant; T represents an absolute temperature; V represents a magnetization reversal volume; A represents a spin precession frequency; and t represents a magnetic field reversal time.

(5) Output and Noise (Disk):

A recording head (MIG, gap: 0.15 μm, 1.8 T) and a reproducing GMR head were mounted on a spin stand and provided for measurement. The number of revolution of the medium and the recording wavelength were set up at 4,000 rpm and 0.2 μm, respectively. With respect to the noise, a modulation noise was measured. The output, noise and S/N ratio were expressed, with the medium No. 1 being taken as 0 dB.

(6) Overwrite (OW):

On the foregoing spin stand, (A) signals at a recording wavelength of 0.9 μm were recorded and an output was then measured; and (B) overwrite was carried out at a recording wavelength of 0.2 μm and an output at a recording wavelength of 0.8 μm was measured. The overwrite was expressed in terms of (A-B), with the medium No. 1 being taken as 0 dB.

The results are shown in Table 1.

TABLE 1

| | | | | | | | | | Thickness | | | | |
|---|---|---|---|---|---|---|---|---|---|---|---|---|---|
| | | | Tabular | | | | | Packing | of | | | | |
| | | Magnetic | size | Tabular | Hc | | | density | magnetic | Output | Noise | S/N | OW |
| No. | Example | material | (nm) | ratio | (Oe) | SQ | V | (g/mL) | layer (nm) | (dB) | (dB) | (dB) | (dB) |
| 1 | Comparative | A | 25 | 2.8 | 2700 | 0.48 | 6 | 2.4 | 80 | 0 | 0 | 0 | 0 |
| | Example | | | | | | | | | | | | |
| 2 | Example | B | 25 | 2.8 | 3500 | 0.50 | 6 | 2.4 | 80 | 1.9 | 0.6 | 1.3 | −1.5 |
| 3 | Example | C | 25 | 2.5 | 3500 | 0.50 | 6 | 2.5 | 80 | 3 | 0.7 | 2.3 | −1.6 |
| 4 | Example | D | 23 | 2.8 | 3500 | 0.50 | 3 | 2.4 | 80 | 1.6 | −0.5 | 2.1 | −1.5 |
| 5 | Example | B | 25 | 2.8 | 3500 | 0.50 | 6 | 2.4 | 40 | 1.2 | −0.3 | 1.5 | 1.6 |
| 6 | Example | E | 25 | 2.8 | 4000 | 0.52 | 6 | 2.4 | 80 | 2.2 | 0.7 | 1.5 | −2.5 |
| 7 | Example | F | 25 | 2.8 | 3100 | 0.49 | 6 | 2.4 | 80 | 1.1 | 0 | 1.1 | −0.3 |
| 8 | Comparative | G | 25 | 2.8 | 4500 | 0.54 | 6 | 2.4 | 80 | −0.6 | −0.5 | −0.1 | −3.5 |
| | Example | | | | | | | | | | | | |
| 9 | Example | H | 25 | 2.3 | 3500 | 0.50 | 6 | 2.6 | 80 | 3.2 | 0.8 | 2.4 | −1.7 |
| 10 | Comparative | I | 25 | 3.5 | 3500 | 0.49 | 6 | 2.3 | 80 | −0.5 | −0.2 | −0.3 | −1.6 |
| | Example | | | | | | | | | | | | |
| 11 | Comparative | J | 35 | 2.8 | 3500 | 0.50 | 12 | 2.5 | 80 | 2.5 | 2.5 | 0 | −1.3 |
| | Example | | | | | | | | | | | | |
| 12 | Comparative | K | 18 | 2.8 | 3500 | 0.49 | 0.6 | 2.2 | 80 | −1.6 | −1.5 | −0.1 | −2.1 |
| | Example | | | | | | | | | | | | |
| 13 | Comparative | B | 25 | 2.8 | 3460 | 0.51 | 6 | 2.4 | 20 | −2.5 | −1.2 | −1.3 | 4.6 |
| | Example | | | | | | | | | | | | |
| 14 | Comparative | B | 25 | 2.8 | 3500 | 0.51 | 6 | 2.4 | 120 | 2.2 | 0.7 | 1.5 | −3.9 |
| | Example | | | | | | | | | | | | |
| 15 | Example | L | 25 | 2.3 | 3800 | 0.51 | 4 | 2.6 | 60 | 3.7 | 0.5 | 3.2 | −1.1 |

Note)
V represents a magnetization reversal volume (unit: ×10⁻¹⁸ cm³). The packing density is a packing density of the hexagonal ferrite in the magnetic layer.

As shown in the foregoing Examples, the magnetic recording media according to the invention are excellent in the noise, output and S/N characteristics.

This application is based on Japanese Patent application JP 2004-180710, filed Jun. 18, 2004, the entire content of which is hereby incorporated by reference, the same as if set forth at length.

1. A magnetic recording medium comprising: a non-magnetic support; and a magnetic layer comprising a hexagonal ferrite and a binder, wherein the magnetic layer has a thickness of from 30 to 100 nm, a coercive force of from 3,000 to 4,200 Oe and a magnetization reversal volume of from 1×10⁻¹⁸ to 10×10⁻¹⁸ mL, and the hexagonal ferrite has a tabular ratio of from 2 to 3.

2. The magnetic recording medium according to claim 1, which further comprises a non-magnetic layer between the non-magnetic support and the magnetic layer, the non-magnetic layer comprising non-magnetic powder and a binder.

3. The magnetic recording medium according to claim 2, wherein the non-magnetic layer has a thickness of from 0.5 to 2.0 μm.

4. The magnetic recording medium according to claim 2, wherein the non-magnetic layer has a thickness of from 0.8 to 1.5 μm.

5. The magnetic recording medium according to claim 2, wherein the non-magnetic layer has a thickness of from 0.8 to 1.2 μm.

6. The magnetic recording medium according to claim 2, wherein the non-magnetic powder has a mean particle size of from 5 nm to 2 μm.

7. The magnetic recording medium according to claim 2, wherein the non-magnetic powder has a mean particle size of from 10 nm to 200 nm.

8. The magnetic recording medium according to claim 2, wherein the non-magnetic layer further comprises carbon black.

9. The magnetic recording medium according to claim 1, wherein the magnetic layer has a thickness of from 40 to 80 nm.

10. The magnetic recording medium according to claim 1, wherein the magnetic layer has a coercive force of from 3,200 to 4,000 Oe.

11. The magnetic recording medium according to claim 1, wherein the magnetic layer has a magnetization reversal volume of from 3×10⁻¹⁸ to 7×10⁻¹⁸ mL.

12. The magnetic recording medium according to claim 1, wherein the hexagonal ferrite has a tabular ratio of from 2 to 2.5.

13. The magnetic recording medium according to claim 1, wherein the hexagonal ferrite contains Ba and Fe at a ratio of Ba to Fe of from 0.075 to 0.085.

14. The magnetic recording medium according to claim 1, wherein the magnetic layer further comprises carbon black.
